(19) United States
(12) Patent Application Publication
(10) Pub. No.: US 2023/0043281 A1
(43) Pub. Date: Feb. 9, 2023

(54) A CONSTRUCTION PANEL HAVING IMPROVED DIMENSIONAL STABILITY

(71) Applicant: Saint-Gobain Placo, Courbevoie (FR)

(72) Inventors: Jan Rideout, East Leake (GB); Nicholas Jones, East Leake (GB); Laura Brooks, East Leake (GB); Helene Retot, Courbevoie (FR); Richard Morlat, Courbevoie (FR); Benoit Montigny, Courbevoie (FR)

(21) Appl. No.: 17/758,795

(22) PCT Filed: Jan. 27, 2021
(86) PCT No.: PCT/EP2021/051886

§ 371 Date: Jul. 13, 2022

(30) Foreign Application Priority Data
Feb. 12, 2020 (FR) FR2001386

(51) Int. Cl. C04B 28/14; C04B 14/42; C04B 24/26; C04B 24/38; C04B 22/16

(52) U.S. Cl. CPC C04B 28/14; C04B 14/42; C04B 24/2623; C04B 24/38; C04B 22/16; C04B 2111/0062

(57) ABSTRACT

Lightweight construction panels, such as gypsum plaster-board, are commonly used to provide internal partitions in buildings It is known to cover, either partially or fully, the panel with an aqueous material such as gypsum plaster or jointing compound. It has been found that known panels expand when they absorb water. This gives rise to several undesirable results such as the gypsum plaster or jointing compound cracking as the panel expands as moisture is absorbed. The present invention provides a panel comprising a gypsum matrix including fibres in an amount of at least 0.8 wt % relative to the gypsum, a polymeric additive in an amount of at least 0.8 wt % relative to the gypsum, and at least one phosphate additive. A panel having such a composition has been found to have desirable characteristics.

### FIELD OF THE INVENTION

The present invention relates to panels for use in building construction, and in particular, to a panel having improved dimensional stability.

### BACKGROUND OF THE INVENTION

Lightweight construction panels, such as plasterboard, (e.g. gypsum plasterboard) are commonly used to provide internal partitions in buildings. To provide a partition, it is typical to first construct a framework from wood, metal, or another suitable material, and affix sheets of plasterboard to the frame with screws or other fixings to provide a continuous partition surface. It is also known to affix said panels to solid walls, such as brick walls, to provide a more desirable finished surface. Said panels are typically used to construct walls and ceilings. Once the panels are affixed to the framework or wall, it is known to finish the partition by either filling the joints and screw head depressions or covering the entire panel with a finishing material, such as cement plaster or gypsum plaster. It is also known to paint such panels.

Typical finishing materials are aqueous. Due to the composition of said panels, they are known to absorb water. Accordingly, when the finishing material is applied to the panel, it is known that the panel will absorb water from the finishing material.

Furthermore, it has been found that known panels expand when they absorb water. In certain circumstances, such as extreme conditions of high humidity, this gives rise to several undesirable results. A first result is that the finishing material may be cracked or damaged as the panel expands as moisture is absorbed, and also as the panel dries out and returns to its original size and shape. A second result is that the panels themselves, or the framework to which they are affixed, may be damaged. This is particularly relevant in partitions which use a framework with a relatively low strength.

Objects and aspects of the present invention seek to alleviate at least these problems with prior known construction panels.

### SUMMARY OF THE INVENTION

According to a first aspect of the present invention, there is provided a panel comprising: a gypsum matrix; and fibres embedded in the gypsum matrix in an amount of at least 0.8 wt % relative to the gypsum; wherein the gypsum matrix comprises: a polymeric additive in an amount of at least 0.8 wt % relative to the gypsum; and a phosphate additive.

A key advantage of the present invention is that a panel having the composition as described above has a greater dimensional stability when wetted, when compared to prior known panels. The applicant has surprisingly discovered that it is especially important for panels including relatively large amounts of fibres and polymeric additive to have good dimensional stability. Panels including large amounts of polymeric additive and fibre have increased stiffness. As such, when these panels are installed within a constrained system, such as a partition wall, any change in dimension can result in significant bowing, bending or cracking, when compared to panels without large amounts of polymeric additive and fibre.

The panel may be used in construction. For example, the panel may be used, along with a supporting frame, to provide an internal partition in a building. The panel may be plasterboard, drywall, sheetrock, gyp board, wallboard or any other known construction panel. The panel may be any construction panel which expands when wetted.

Once in position, the panel may be jointed, wherein the joints between adjacent panels are filled such that a continuous outer surface is provided. Depressions due to screw heads may also be filled in this way. Alternatively, the entire panel may be covered once in position. The panel may be jointed or entirely covered in a gypsum plaster, a cement plaster, a jointing compound or other material configured to set and/or dry.

The panel may comprise backing paper on one or more surfaces. The backing paper may allow moisture to pass therethrough.

In the production of plasterboards, it is typical that a slurry comprising calcium sulphate hemihydrate (stucco) with the chemical formula CaSO₄ ½.(H₂O) is converted to calcium sulphate dihydrate (gypsum) with the chemical formula CaSO₄ 2.(H₂O) during a drying step. Due to the hydration of the stucco during the process, the weight of the calcium sulphate based component is higher in the plasterboard than in the slurry. The molar mass of stucco is 0.84 that of calcium sulphate dihydrate. As such, the weight of an additive relative to the stucco in the slurry is higher than the weight of the additive relative to the gypsum in the final plasterboard product.

The gypsum matrix may be friable. The gypsum matrix may be cast from a stucco slurry and/or pressed into a panel.

The fibres being embedded in the gypsum matrix may mean that the fibres are set in the gypsum matrix. Each fibre, or cluster of fibres, may be surrounded by the gypsum matrix. The fibres may be distributed evenly throughout the gypsum matrix. Alternatively, the fibres may be unevenly distributed throughout the gypsum matrix. For example, the density of fibres may be greater adjacent a first surface of the panel when compared to a second, opposite, surface of the panel.

The fibres may be provided in an amount in the range 0.8-7 wt % relative to the gypsum. Alternatively, the fibres may be provided in an amount in the range 1.6-5 wt % relative to the gypsum. For example, the fibres may be provided in an amount of approximately 1.6 wt %, 1.7 wt %, 1.9 wt %, 2.5 wt %, 3.0 wt %, 4.0 wt %, 4.5 wt % or 5 wt % relative to the gypsum. The fibres may be provided in a maximum amount of 7 wt % relative to the gypsum.

The phosphate additive may be selected from a group consisting of: metaphosphates, polyphosphates, trimetaphosphates, sodium trimetaphosphate (STMP) tetrasodium pyrophosphate (TSPP) and mixtures thereof.

The phosphate additive may be present in an amount of at least 0.04 wt %, 0.08 wt %, 0.21 wt %, 0.25 wt %, 0.42 wt %, 0.5 wt %, 0.84 wt % or 2.5 wt % relative to the gypsum. The addition of a phosphate additive may act to improve the dimensional stability of the panel. In particular, the phosphate additive may reduce the expansion of the panel when the panel is moistened.

The phosphate additive may be provided in a minimum amount required to provide preferable panel characteristics. For example, the phosphate additive may be STMP and may be provided in an amount of 0.08 wt % relative to the gypsum. This particular phosphate additive, and said amount, have been found to provide preferable panel characteristics. A lesser amount of STMP may not provide preferable panel characteristics. A greater amount of STMP may provide more preferable panel characteristics, but the increase in performance from that seen in a panel including 0.08 wt % STMP relative to the gypsum may not justify the addition of STMP in the greater amount.

The fibres may be present in an amount of at least 1.7 wt % relative to the gypsum. The polymeric additive may be provided in an amount of at least 3.7 wt % relative to the gypsum.

A polymeric additive may be a polymer which is added to the gypsum matrix.

The polymeric additive may combine with the gypsum matrix. Alternatively, the polymeric additive may remain distinct within the gypsum matrix. The polymeric additive may be selected from a group consisting of: polyvinyl acetate, polyvinyl acetate-ethylene co-polymer, polyvinyl pyrrolidone cross-linked with polystyrene sulfonate, polyvinyl alcohol, methyl cellulose, hydroxyethyl methyl cellulose, styrene-butadiene copolymer latex, acrylic ester latex, acrylic copolymer latex, polyester resin, epoxy resin, polymethyl methacrylate, polyacrylic acid, a starch and mixtures thereof.

The starch may be selected from a group consisting of: cationic starch, ethylated starch, dextrin, pre-gelatinised starch, substituted starch, a migratory starch, a non-migratory starch, an acid-thinned starch, a native starch, a starch having a Brookfield viscosity of less than 60 cps at a temperature below 60° C. and a Brookfield viscosity greater than 10,000 cps at a temperature of 70° C., and mixtures thereof.

Said Brookfield viscosity may be measured by creating a solution by dissolving 100 g of starch on 600 ml of water at a temperature of 20° C., wherein the solution is brought to 60° C. and then heated at a rate of 1° C./min up to 90° C., using a Brookfield viscometer adapted for measuring viscosities from 1 to 100,000 cps with the number 6 spindle at a speed of 10 rpm, allowing the maximum result to be directly read off the Brookfield viscometer between 50% and 80% of the range on the scale, whereas another spindle may be selected outside said range on the scale.

The polymeric additive may be provided in an amount in the range 0.8-9 wt % relative to the gypsum. Accordingly, the polymeric additive may be provided in a maximum amount of 9 wt % relative to the gypsum. Alternatively, the polymeric additive may be provided in an amount in the range 0.8-7 wt % relative to the gypsum. Alternatively, the polymeric additive may be provided in an amount in the range 2.1-5 wt % relative to the gypsum. For example, the polymeric additive may be provided in an amount of approximately 1.6 wt %, 2.1 wt %, 2.9 wt %, 3.8 wt %, 4.2 wt %, 4.4 wt % or 5 wt % relative to the gypsum. The polymeric additive may be provided in a maximum amount of 7 wt % relative to the gypsum.

The polymeric additive may comprise polyvinyl acetate in an amount of at least 1.9 wt % relative to the gypsum. Alternatively, the polymeric additive may comprise polyvinyl acetate in an amount of at least 3.8 wt % relative to the gypsum.

The polymeric additive may comprise starch in an amount of at least 2.5 wt % relative to the gypsum. Alternatively, the polymeric additive may comprise starch in an amount of at least 5.0 wt % relative to the gypsum.

The values of additives disclosed above have been found to provide preferably dimensional stability characteristics.

The fibres may comprise glass fibres. Alternatively, or additionally, the fibres may comprise wood fibres, fibres derived from wood, regenerated cellulose fibres and/or synthetic polymer fibres. Each fibre may be elongate. The inclusion of fibres may reduce the friability of the gypsum matrix and/or improve a nail pull-out strength of the panel.

The fibres may have a length in the range 4-8 mm. Alternatively, the fibres may have a length on the range 2-10 mm. For example, the fibres may have a length of approximately 6 mm. The fibres may have a diameter in the range 5-80 micron. Alternatively, the fibres may have a diameter in the range 2-150 micron. It is to be understood that the lengths and diameters referred to herein may be a mean, median or modal length or diameter. Furthermore, the lengths and diameters referred to herein may be the length or diameter of the fibres as present in the panel. It is to be understood that a portion of the fibres may be damaged and reduced in length or diameter during the manufacture and subsequent use of the panel.

The fibres may be present in the panel in the form of particles of agglomerated fibres, for example, paper particles and/or wood particles such as fine sawdust particles. Typically, said particles are irregular in shape.

The composition may have a water gauge in the range 60-90%, preferably 60-80%, more preferably 60-70%. For example, the composition may have a water gauge of approximately 65%.

According to a second aspect of the present invention, there is provided a method of manufacturing the panel according to the first aspect, the method comprising the steps: adding the fibres to a stucco slurry; adding the polymeric additive to the stucco slurry; adding the phosphate additive to the stucco slurry; and drying the stucco slurry to form the panel. Typically, the slurry comprises mainly calcium sulphate hemihydrate (stucco), which is converted to calcium sulphate dihydrate during the drying step. The molar mass of calcium sulphate hemihydrate is 0.84 that of calcium sulphate dihydrate.

The step of adding the phosphate additive to the stucco slurry may comprise adding the phosphate additive as a dry solid. Alternatively, or additionally, the step of adding the phosphate additive to the stucco slurry may comprise adding the phosphate additive as a solution. The solution may be a water based solution. The percentages referred to above may be the relative percentage of the solids content of the solution, when compared to the gypsum.

The step of adding the polymeric additive to the stucco slurry may comprise adding polymeric additive as a dry solid. Alternatively, or additionally, the step of adding the polymeric additive to the stucco slurry may comprise adding the polymeric additive as a solution. The solution may be a water based solution. The percentages referred to above may be the relative percentage of the solids content of the solution, when compared to the gypsum.

The method may further comprise the step of drying the stucco slurry at a temperature in the range 100-250° C. The step of drying the stucco slurry may comprise a plurality of drying stages. Each drying stage may be carried out at a different temperature to at least one other drying stage. For example, the step of drying the stucco slurry may comprise a first drying step at approximately 250° C. and a second drying step at approximately 100° C.

The method may further comprise the step of agitating or mixing the stucco slurry to evenly distribute the fibres and/or additives.

The method may further comprise the step of placing the stucco slurry into a form. The form may determine the shape of the panel produced via the method.

### DETAILED DESCRIPTION

An embodiment of the present invention will now be described by way of example only and with reference to the accompanying drawings, in which:

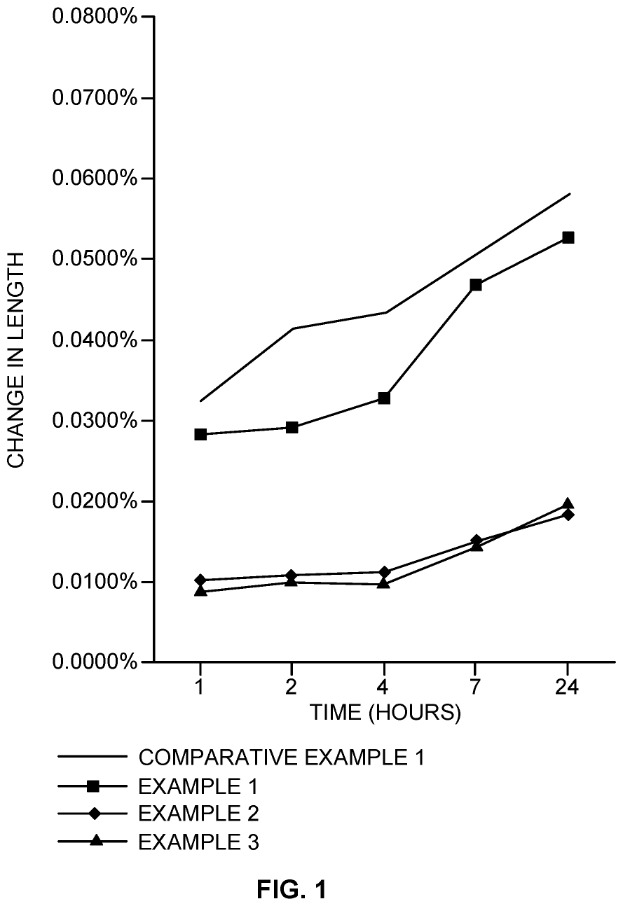

FIG. 1 is a schematic graph of percentage change in length against time for Examples 1-3 and Comparative Example 1;

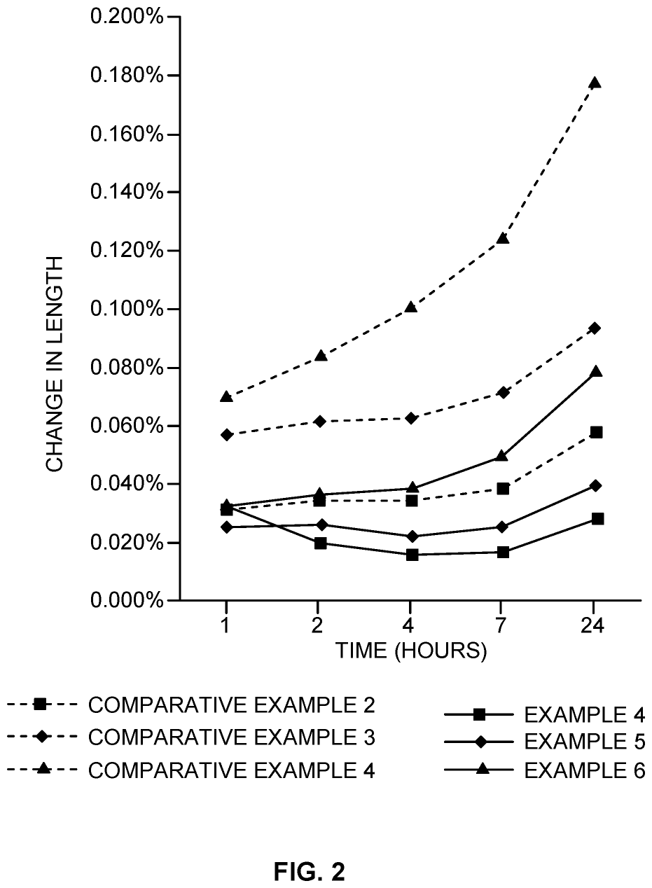

FIG. 2 is a schematic graph of percentage change in length against time for Examples 4-6 and Comparative Examples 2-4; and

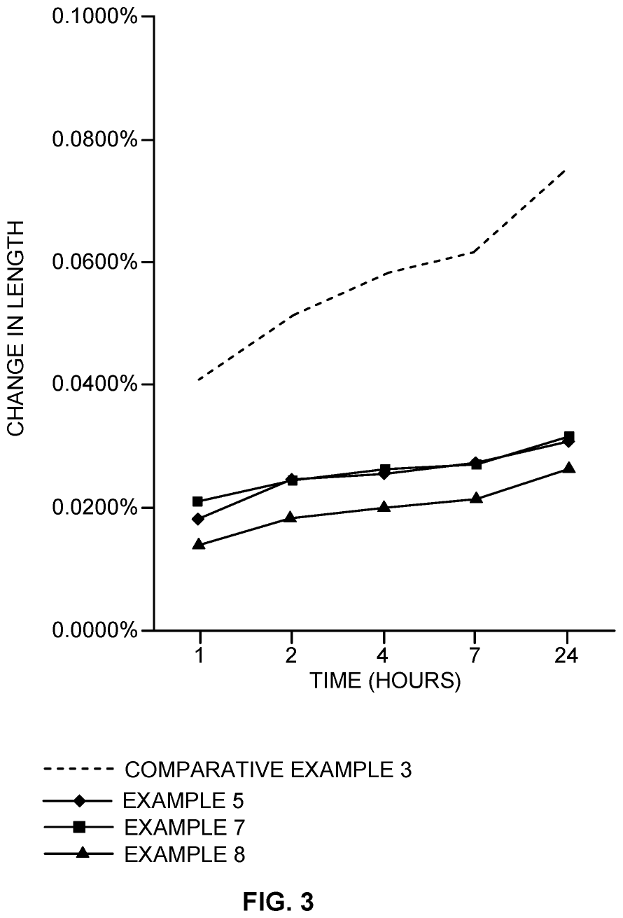

FIG. 3 is a schematic graph of percentage change in length against time for Examples 5, 7 and 8 and Comparative Example 3.

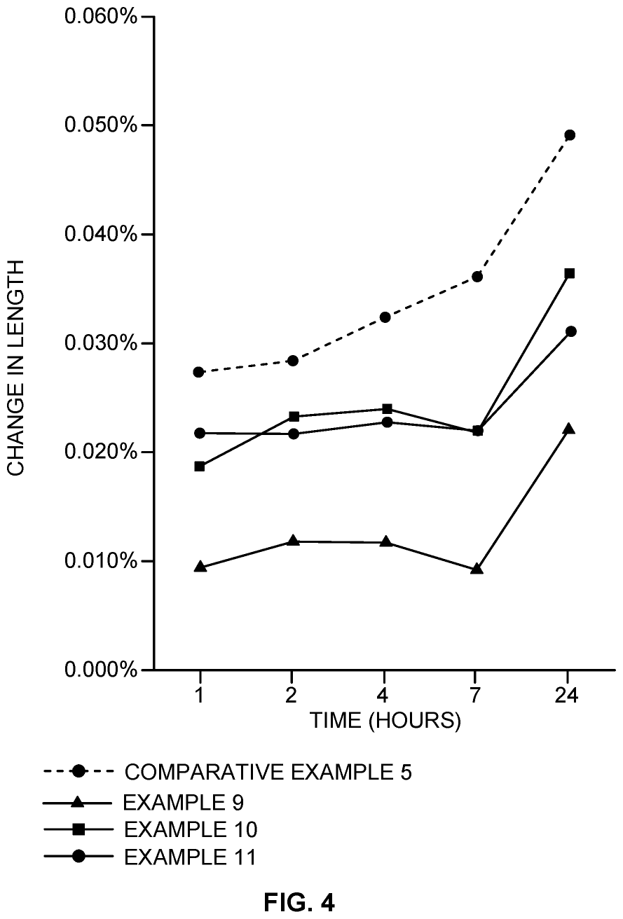

FIG. 4 is a schematic graph of percentage change in length against time for Examples 9, 10 and 11 and Comparative Example 5.

FIG. 1 is a schematic graph of percentage change in length against time. The graph of FIG. 1 includes data collected from tests on Examples 1-3 and Comparative Example 1. The graph shows a plot of percentage change in length against submersion time in hours. Test panels were produced with the compositions as discussed below. The initial length of each test panel was noted. The test panels were then submerged in water. The length of each test panel was measured after 1 hour, 2 hours, 4 hours, 7 hours and 24 hours of submersion in the water.

### EXAMPLES 1-3

Gypsum plasterboards were prepared from the compositions described below.

### Example 1

A gypsum plasterboard was prepared from a slurry containing the following, wherein all percentage values given are relative to the weight of the stucco:
stucco in an amount of 100%;
6 mm long glass fibres in an amount of 2.4%;
polyvinyl acetate in an amount of 4.5%;
80% water gauge; and
STMP in an amount of 0.05%.

### Example 2

A gypsum plasterboard was prepared from a slurry containing the following, wherein all percentage values given are relative to the weight of the stucco:
stucco in an amount of 100%;
6 mm long glass fibres in an amount of 2.4%;
polyvinyl acetate in an amount of 4.5%;
80% water gauge; and
STMP in an amount of 1%.

### Example 3

A gypsum plasterboard was prepared from a slurry containing the following, wherein all percentage values given are relative to the weight of the stucco:
stucco in an amount of 100%;
6 mm long glass fibres in an amount of 2.4%;
polyvinyl acetate in an amount of 4.5%;
80% water gauge; and
STMP in an amount of 3%.

### Comparative Example 1

A comparative gypsum plasterboard was prepared from a slurry containing the following, wherein all percentage values given are relative to the weight of the stucco:
stucco in an amount of 100%;
6 mm long glass fibres in an amount of 2.4%;
polyvinyl acetate in an amount of 4.5%; and
80% water gauge.

As can be seen in the graph of FIG. 1, Example 1, having STMP in an amount of 0.05 wt % relative to the stucco, performs better than Comparative Example 1, which has no STMP. A better performance is to be understood as having a lower percentage change in length. Furthermore, Examples 2 and 3, having STMP in an amount of 1 wt % and 3 wt % relative to the stucco respectively, both perform considerably better than Example 1. Therefore, a first conclusion that can be drawn is that a higher level of STMP reduces dimensional variability due to exposure to moisture.

However, it can also be seen that Examples 2 and 3 performed similarly. Therefore, a second conclusion that can be drawn is that having 3 wt % STMP relative to the stucco performs similarly to having only 1 wt % relative to the stucco. Accordingly, there may be a saturation point in the range of 0.05 wt % to 1 wt % STMP relative to the stucco, wherein an amount of STMP higher than the saturation point does not provide a significant increase in performance.

FIG. 2 is a schematic graph of percentage change in length against time. The graph of FIG. 2 includes data collected from tests on Examples 4-6 and Comparative Examples 2-4. The graph shows a plot of percentage change in length against submersion time in hours. Test panels were produced with the compositions as discussed below. The initial length of each test panel was noted. The test panels were then submerged in water. The length of each test panel was measured after 1 hour, 2 hours, 4 hours, 7 hours and 24 hours of submersion in the water.

### EXAMPLES 4-6

Gypsum plasterboards were prepared from the compositions described below.

### Example 4

A gypsum plasterboard was prepared from a slurry containing the following, wherein all percentage values given are relative to the weight of the stucco:
stucco in an amount of 100%;
6 mm long glass fibres in an amount of 2.4%;
polyvinyl acetate in an amount of 2.25%;
80% water gauge; and
STMP in an amount of 0.1%.

### Example 5

A gypsum plasterboard was prepared from a slurry containing the following, wherein all percentage values given are relative to the weight of the stucco:
stucco in an amount of 100%;
6 mm long glass fibres in an amount of 2.4%;
polyvinyl acetate in an amount of 2.25%;
modified starch in an amount of 3%;
80% water gauge; and
STMP in an amount of 0.1%.

### Example 6

A gypsum plasterboard was prepared from a slurry containing the following, wherein all percentage values given are relative to the weight of the stucco:
stucco in an amount of 100%;
6 mm long glass fibres in an amount of 2.4%;
modified starch in an amount of 3%;
80% water gauge; and
STMP in an amount of 0.1%.

### Comparative Example 2

A comparative gypsum plasterboard was prepared from a slurry containing the following, wherein all percentage values given are relative to the weight of the stucco:
stucco in an amount of 100%;
6 mm long glass fibres in an amount of 2.4%;
polyvinyl acetate in an amount of 2.25%; and
80% water gauge.

### Comparative Example 3

A comparative gypsum plasterboard was prepared from a slurry containing the following, wherein all percentage values given are relative to the weight of the stucco:
stucco in an amount of 100%;
6 mm long glass fibres in an amount of 2.4%;
polyvinyl acetate in an amount of 2.25%;
modified starch in an amount of 3%; and
80% water gauge.

### Comparative Example 4

A comparative gypsum plasterboard was prepared from a slurry containing the following, wherein all percentage values given are relative to the weight of the stucco:
stucco in an amount of 100%;
6 mm long glass fibres in an amount of 2.4%;
modified starch in an amount of 3%; and
80% water gauge.

As can be seen in the graph of FIG. 2, Example 4, having polyvinyl acetate in an amount of 2.25 wt % relative to the stucco and STMP in an amount of 0.1 wt % relative to the stucco, performs better than Comparative Example 2, which has polyvinyl acetate in an amount of 2.25 wt % relative to the stucco and no STMP. A better performance is to be understood as having a lower percentage change in length.

Furthermore, as can be seen in the graph of FIG. 2, Example 5, having polyvinyl acetate in an amount of 2.25 wt % relative to the stucco, modified starch in an amount of 3 wt % relative to the stucco and STMP in an amount of 0.1 wt % relative to the stucco, performs better than Comparative Example 3, which has polyvinyl acetate in an amount of 2.25 wt % relative to the stucco, modified starch in an amount of 3 wt % relative to the stucco and no STMP. A better performance is to be understood as having a lower percentage change in length.

Also, as can be seen in the graph of FIG. 2, Example 5, having modified starch in an amount of 3 wt % relative to the stucco and STMP in an amount of 0.1 wt % relative to the stucco, performs better than Comparative Example 4, which has modified starch in an amount of 3 wt % relative to the stucco and no STMP. A better performance is to be understood as having a lower percentage change in length.

Therefore, a conclusion that can be drawn is that the addition of STMP in an amount of 0.1 wt % relative to the stucco improves the performance of panels having polyvinyl acetate, modified starch and a combination thereof as an additive.

FIG. 3 is a schematic graph of percentage change in length against time. The graph of FIG. 3 includes data collected from tests on Examples 5, 7 and 8 and Comparative Example 3. The graph shows a plot of percentage change in length against submersion time in hours. Test panels were produced with the compositions as discussed below. The initial length of each test panel was noted. The test panels were then submerged in water. The length of each test panel was measured after 1 hour, 2 hours, 4 hours, 7 hours and 24 hours of submersion in the water.

The compositions of Example 5 and Comparative Example 3 are discussed above with reference to FIG. 2.

### EXAMPLES 7 AND 8

Gypsum plasterboards were prepared from the compositions described below.

### Example 7

A gypsum plasterboard was prepared from a slurry containing the following, wherein all percentage values given are relative to the weight of the stucco:
stucco in an amount of 100%;
6 mm long glass fibres in an amount of 2.4%;
polyvinyl acetate in an amount of 2.25%;
modified starch in an amount of 3%;
80% water gauge; and
STMP in an amount of 0.25%.

### Example 8

A gypsum plasterboard was prepared from a slurry containing the following, wherein all percentage values given are relative to the weight of the stucco:
stucco in an amount of 100%;
6 mm long glass fibres in an amount of 2.4%;
polyvinyl acetate in an amount of 2.25%;
modified starch in an amount of 3%;
80% water gauge; and
STMP in an amount of 0.5%.

As can be seen in the graph of FIG. 3, Examples 5 and 7, having STMP in an amount of 0.1 wt % relative to the stucco and 0.25 wt % relative to the stucco respectively, perform similarly and better than Comparative Example 3, which has no STMP. A better performance is to be understood as having a lower percentage change in length. Accordingly, a conclusion that may be drawn is that STMP in an amount in the range 0.1-0.25 wt % relative to the stucco performs similarly.

Furthermore, as can be seen in the graph of FIG. 3, Example 8, having STMP in an amount of 0.5 wt % relative to the stucco, performs better than Comparative Example 3, which has no STMP, and Examples 5 and 7 which have STMP in an amount of 0.1 wt % relative to the stucco and 0.25 wt % relative to the stucco respectively. A better performance is to be understood as having a lower percentage change in length. Accordingly, another conclusion that may be drawn is that STMP in an amount of 0.5 wt % relative to the stucco performs better than lower levels of STMP, such as in the range 0.1-0.25 wt % relative to the stucco. Accordingly providing STMP in an amount greater than 0.25 wt % may provide better performance.

FIG. 4 is a schematic graph of percentage change in length against time. The graph of FIG. 4 includes data collected from tests on Examples 9 to 11 and Comparative Example 5. The graph shows a plot of percentage change in length against submersion time in hours. Test panels at full commercial scale were produced with the compositions as discussed below. The initial length of each test panel was noted. The test panels were then submerged in water. The length of each test panel was measured after 1 hour, 2 hours, 4 hours, 7 hours and 24 hours of submersion in the water.

### EXAMPLES 9-11

Gypsum plasterboards were prepared from the compositions described below.

### Example 9

A gypsum plasterboard was prepared from a slurry containing the following, wherein all percentage values given are relative to the weight of the stucco:
stucco in an amount of 100%;
6 mm long glass fibres in an amount of 2.4%;
polyvinyl acetate in an amount of 4.5%;
80% water gauge; and
STMP in an amount of 1%.

### Example 10

A gypsum plasterboard was prepared from a slurry containing the following, wherein all percentage values given are relative to the weight of the stucco:
stucco in an amount of 100%;
6 mm long glass fibres in an amount of 2.4%;
polyvinyl acetate in an amount of 4.5%;
80% water gauge; and
TSPP in an amount of 1%.

### Example 11

A gypsum plasterboard was prepared from a slurry containing the following, wherein all percentage values given are relative to the weight of the stucco:
stucco in an amount of 100%;
6 mm long glass fibres in an amount of 2.4%;
polyvinyl acetate in an amount of 4.5%;
80% water gauge; and
TSPP in an amount of 0.1%.

### Comparative Example 5

A comparative gypsum plasterboard was prepared from a slurry containing the following, wherein all percentage values given are relative to the weight of the stucco:
stucco in an amount of 100%;
6 mm long glass fibres in an amount of 2.4%;
polyvinyl acetate in an amount of 4.5%; and
80% water gauge.

As can be seen in the graph of FIG. 4, Examples 9 to 11, comprising STMP and TSPP perform better than Comparative Example 5, which has no phosphate additive. A better performance is to be understood as having a lower percentage change in length. Therefore, a first conclusion that can be drawn is that the inclusion of a phosphate additive in a plasterboard reduces dimensional variability due to exposure to moisture.

Furthermore, Example 9, having STMP in an amount of 1 wt % relative to the stucco, performs better than Examples 10 and 11 comprising TSPP in amounts of 1 wt % and 0.1 wt % TSPP relative to the stucco respectively. Therefore, a second conclusion that can be drawn is that, in plasterboards, STMP is more effective than TSPP in reducing dimensional variability due to exposure to moisture.

1. A panel comprising:
a gypsum matrix; and
fibres embedded in the gypsum matrix in an amount of at least 0.8 wt % relative to the gypsum;
wherein the gypsum matrix comprises:
a polymeric additive in an amount of at least 0.8 wt % relative to the gypsum; and
a phosphate additive present in an amount of at least 0.25 wt % relative to the gypsum.

2-3. (canceled)

4. The panel of claim 1, wherein the phosphate additive is present in an amount of at least 0.50 wt % relative to the gypsum.

5. The panel of claim 1, wherein the fibres are present in an amount of at least 1.7 wt % relative to the gypsum, and the polymeric additive is provided in an amount of at least 3.7 wt % relative to the gypsum.

6. The panel of claim 1, wherein the polymeric additive is selected from a group consisting of: polyvinyl acetate, polyvinyl acetate-ethylene co-polymer, polyvinyl pyrrolidone cross-linked with polystyrene sulfonate, polyvinyl alcohol, methyl cellulose, hydroxyethyl methyl cellulose, styrene-butadiene copolymer latex, acrylic ester latex, acrylic copolymer latex, polyester resin, epoxy resin, polymethyl methacrylate, polyacrylic acid, a starch and mixtures thereof.

7. The panel of claim 6, wherein the starch is selected from a group consisting of: cationic starch, ethylated starch, dextrin, pre-gelatinised starch, substituted starch, a migratory starch, an acid-thinned starch, a native starch, a starch having a Brookfield viscosity of less than 60 cps at a temperature below 60° C. and a Brookfield viscosity greater than 10,000 cps at a temperature of 70° C., and mixtures thereof.

8. The panel of claim 6, wherein the polymeric additive comprises polyvinyl acetate in an amount of at least 1.9 wt % relative to the gypsum and starch in an amount of at least 2.5 wt % relative to the gypsum.

9. The panel of claim 6, wherein the polymeric additive comprises polyvinyl acetate in an amount of at least 3.8 wt % relative to the gypsum.

10. The panel of claim 6, wherein the polymeric additive comprises starch in an amount of at least 5.0 wt % relative to the gypsum.

11. The panel of claim 1, wherein the fibres comprise glass fibres, wherein the fibres have a length in the range 4-8 mm and a diameter in the range 5-80 micron.

12. The panel of claim 1, wherein the phosphate additive is selected from a group consisting of: metaphosphates, polyphosphates, trimetaphosphates, sodium trimetaphosphate, tetrasodium pyrophosphate and mixtures thereof.

13. A method of manufacturing the panel according to claim 1, the method comprising the steps:
adding the fibres to a stucco slurry;
adding the polymeric additive to the stucco slurry;
adding the phosphate additive to the stucco slurry; and
drying the stucco slurry to form the panel.

14. The method of claim 13, wherein the phosphate additive is added to the stucco slurry as a dry solid or as a solution.

15. The method of claim 13, wherein at least one polymeric additive is added to the stucco slurry as a dry solid or as a solution.
